(19) United States
(12) Patent Application Publication
(10) Pub. No.: US 2005/0199590 A1
(43) Pub. Date: Sep. 15, 2005

(54) Ceramic tube for vacuum circuit breaker

(76) Inventors: Martin Bernardus Johannes Leusenkamp, Hengelo (NL); Johannes Hermannus Laurentius Antonius Hilderink, Haaksbergen (NL)

Correspondence Address: Kirk D Houser;Eckert Seamans Cherin & Mellott, 600 Grant St, 44th Floor, Pittsburgh, PA, 15219, US

(21) Appl. No.: 10/510,552

(22) PCT Filed: Apr. 9, 2003
(86) PCT No.: PCT/NL03/00267

§ 371 Date: Oct. 7, 2004

(30) Foreign Application Priority Data
Apr. 9, 2002 (NL) 1020347

(51) Int. Cl. H01H 33/66

(52) U.S. Cl. 218/118

(57) ABSTRACT

Ceramic tube for use in a vacuum circuit breaker, the ceramic tube (10) being cylindrical in shape with a set length and a set internal diameter. Furthermore, the ceramic tube has a cylindrical end face (11) at each end of the cylinder shape, it being possible for a metal end cap (4, 6) to be secured in a vacuum-tight manner to each cylindrical end face (11) in order to form a vacuum chamber (8). The cylindrical end face (11) is shaped in such a manner that, in the assembled state, it makes contact with the metal end cap (4, 6) at least as far as the internal diameter of the ceramic tube (10).

The present invention relates to a ceramic tube for use in a vacuum switch or circuit breaker, the ceramic tube being cylindrical in shape with a set length and a set internal diameter, with a cylindrical end face at each end of the cylinder shape, it being possible for a metal end cap to be secured in a vacuum-tight manner, for example by soldering, to each cylindrical end face to form a vacuum chamber. In the vacuum chamber there are two contacts which can be moved apart in order to break a circuit.

On account of their suitable materials properties (insulating, able to withstand high temperature and pressure, etc.), ceramic tubes of this type are used in vacuum circuit breakers for vacuum switches in electrical installations.

With the known ceramic tube, which is in widespread use, for a vacuum circuit breaker (generally in the form of an elongate sleeve), the end faces are bevelled on both sides. This is caused by the way in which the ceramic tube is produced as economically as possible. The aim is to make vacuum circuit breakers ever smaller while continuing to ensure operational reliability. A smaller ceramic tube means that not only can vacuum switches be of more compact construction, but also that less ceramic material is required, making the vacuum circuit breaker ultimately less expensive.

The length of the ceramic tube is largely determined by requirements relating to the ability to resist spark-overs and/or breakdowns. Although in a vacuum a contact spacing of approx. 10 mm is sufficient to prevent a breakdown between the contacts of the vacuum circuit breaker, the ceramic tube which surrounds the vacuum chamber must be longer than 10 mm in order to be able to ensure the dielectric strength. After all, if its dimensions were too small, a sparkover could occur via the ceramic tube.

When the vacuum circuit breaker is produced, a junction is formed where vacuum, metal and ceramic, with their different dielectric properties, adjoin one another; this is referred to in the specialist field as a triple junction. On account of the bevelled shape of the cylindrical end face of the ceramic tube, an acute angle is formed in the vacuum. It has been found that, as a result of the different dielectric properties of the three materials which come together at that point, the field lines continue to pass through the vacuum at this acute angle and the electric field strength is concentrated there and may increase to such an extent that a breakdown may be initiated.

The present invention aims to provide a ceramic tube for use in a vacuum circuit breaker in which the said phenomenon does not occur.

This is achieved by means of a ceramic tube of the type defined in the preamble in which the cylindrical end face is shaped in such a manner that, in the assembled state, it makes contact with the metal end cap at least as far as the internal diameter of the ceramic tube. At the location where the three materials meet, this leads to the field lines being less concentrated locally and therefore to a reduced local field strength, with the result that there is less risk of a breakdown. Simulations using a specific situation have demonstrated a reduction in the field strength by a factor of seven compared to standard ceramic tubes. As a result, the dielectric strength is increased, making it possible to make the ceramic tube somewhat shorter, resulting in a further cost saving, or to allow a higher voltage if the length remains the same.

In one embodiment of the present invention, the cylindrical end face on an inner side of the ceramic tube forms an angle of substantially at most ninety degrees with an inner surface of the ceramic tube. With an angle of less than ninety degrees (so that the cylindrical end face of the ceramic tube continues further towards the inner side of the vacuum circuit breaker along the metal of the end cap), the field strength is in theory reduced still further. However, the production of a tube of this type is less easy and therefore more expensive, making an embodiment of this type less economically attractive. An embodiment with an angle of ninety degrees is therefore preferred for these reasons.

In a further embodiment, the cylindrical end face on an outer side of the ceramic tube forms an angle of at least ninety degrees with an outer surface of the ceramic tube. During production of the vacuum circuit breaker, the end caps are generally soldered onto the ceramic tube. If the cylindrical end faces are straight, it is possible that solder may flow over the edge of the ceramic tube, with the result that the risk of spark-overs via the outer side of the ceramic tube increases. As a result of the cylindrical end faces being bevelled only on the outer side, it would be less easy for solder to flow beyond the external diameter of the ceramic tube, and the risk of spark-overs will decrease.

In a further aspect, the invention relates to a vacuum circuit breaker or switch which is provided with a ceramic tube according to the present invention.

The invention will now be explained in more detail on the basis of a number of exemplary embodiments and with reference to the appended drawings, in which:

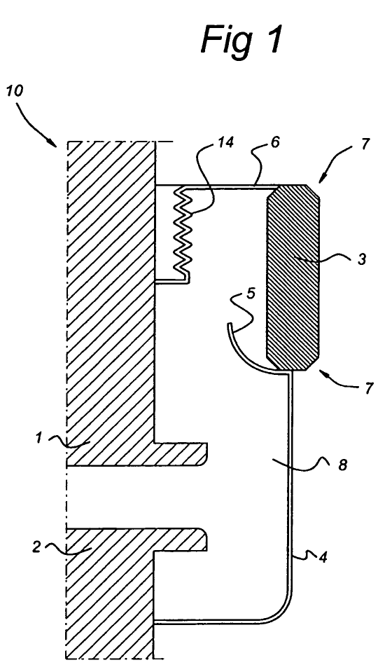

FIG. 1 diagrammatically depicts a cross-sectional view through a vacuum circuit breaker according to the prior art;

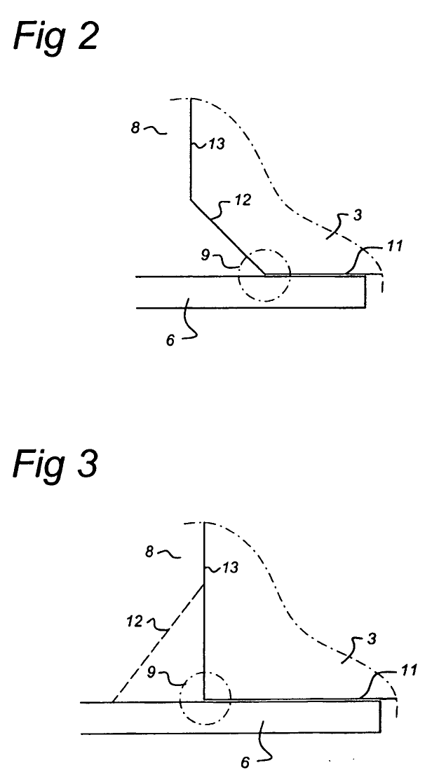

FIG. 2 shows an enlarged view of part of the cross-sectional view shown in FIG. 1;

FIG. 3 shows an enlarged view of part of a vacuum circuit breaker with a ceramic tube in accordance with an embodiment of the present invention.

FIG. 1 shows a simplified cross-sectional view through a vacuum circuit breaker 10 as used in vacuum switches for electrical installations. The vacuum circuit breaker 10 comprises a moveable contact 1 and a fixed contact 2, which form part of an electric circuit. A circuit is broken as a result of the contacts 1,2 being moved apart. The contacts 1,2 are located in a vacuum chamber 8, so that any arc formed during breaking of the circuit is extinguished immediately. The vacuum chamber 8 is formed by a ceramic tube 3 and two end caps 4,6 made from a metal. The end caps 4,6 are generally joined to the ceramic tube 8 by soldering. Furthermore, the vacuum circuit breaker 10 may be provided with a screen 5 which is likewise made from metal and adjoins the end cap 4, and a bellows 14 which adjoins the end cap 6 enables the moving contact 1 to move into vacuum chamber 8.

The ceramic tube 3 is produced by sintering ceramic powder in a mould. This is a production technique which is in widespread use because it is relatively simple and therefore inexpensive and economically attractive, but has the result that the cylindrical end faces 11 of the ceramic tube 3 are bevelled, as indicated by reference numeral 7 in FIG. 1.

FIG. 2 shows a detailed enlargement of the location at which the end cap 6 adjoins the ceramic tube 3. The detailed enlargement shows part of the end cap 6 which is secured to the cylindrical end face 11 of the ceramic tube 3 by means of a soldered joint, for example. On account of the bevel 12 (corresponding to reference numeral 7 in FIG. 1) of the cylindrical end face 11 of the ceramic tube 3, an acute angle is formed in the vacuum chamber 8 at the location where vacuum interior 8, ceramic tube 3 and the metal of the end cap 6 meet (a triple junction, denoted by reference numeral 9). The bevel 12 of the inner wall 13 of the ceramic tube 3 forms an obtuse angle, i.e. an angle of greater than ninety degrees, with the cylindrical end face 11 of the ceramic tube 3.

At the triple junction 9 where the three materials (vacuum, metal and ceramic) meet, it has been found that when the vacuum circuit breaker 10 is interrupted, an operation which involves considerable potential differences occurring in the vacuum interior 8, very high electric fields are formed, concentrated primarily in the triple junction 9. This concentration of electric fields increases the risk of a breakdown or sparkover occurring from this location.

This situation can be improved by shaping the cylindrical end face of the ceramic tube 3 in the manner shown in the enlarged cross-sectional view presented in FIG. 3. Here, the cylindrical end face 11 of the ceramic tube 3 forms a right angle with the inner wall 13. Depending on the other conditions, this configuration can reduce the field strength at a triple junction 9 where the three materials meet by a factor of seven. As a result, the risk of a breakdown or sparkover being initiated is considerably lower than in the situation described above.

In other words, the cylindrical end face 11 of the ceramic tube 3 extends towards the inner side and makes contact with the metal of the end cap 6 at least as far as the interior diameter of the ceramic tube 3. The electric field distribution could in theory be even better if the cylindrical end face 11 of the ceramic tube 3 extends still further inwards: the cylindrical end face 11 then forms an angle of less than ninety degrees with the bevel 12 (indicated by a dashed line) of the inner surface 13 of the ceramic tube. However, a tube 3 of this shape is even more difficult to produce and process in the manufacture of vacuum circuit breakers 10, and is therefore more expensive. For economic reasons, a tube of this type is not attractive.

Although it is more expensive to produce a ceramic tube 3 with straight cylindrical end faces 11 compared to the conventional tube with bevelled cylindrical end faces, the result is a tube which offers significant technical benefits. As a result, it is possible either to use a shorter ceramic tube 3, with the result that the costs of the ceramic tube 3 are reduced, or to use the same tube for higher voltages.

According to the invention, however, it is preferable to use a bevelled cylindrical end face 11 on the outer side of the ceramic tube 3, as indicated in FIG. 1. Since the end caps 4,6 are secured to the ceramic tube 3 by a soldered joint, with a straight cylindrical end face 11 it is possible that a small amount of the solder may flow over the edge of the ceramic tube 3. Beads of solder of this type at the outer edges of the two ends of the ceramic tube 3 could act as a location for breakdowns on the outer side of the ceramic tube 3 (the soldered edges are as it were poking out in the electrical sense).

On account of the bevelled edges 7, any solder which may flow out will find it more difficult to flow beyond the external diameter of the ceramic tube 3, resulting in an improved resistance to breakdowns. This also results in a technical advantage, making it possible either to reduce the length of the ceramic tube 3, with the result that the vacuum circuit breaker 10 can be produced at lower cost, or to use a higher voltage for the same tube.

1. Ceramic tube for use in a vacuum circuit breaker, the ceramic tube being cylindrical in shape with a set length and a set internal diameter, with a cylindrical end face at each end of the cylinder shape, it being possible for a metal end cap to be secured in a vacuum-tight manner to each cylindrical end face to form a vacuum chamber, characterized in that the cylindrical end face is shaped in such a manner that, in the assembled state, it makes contact with the metal end cap at least as far as the internal diameter of the ceramic tube in order to prevent, in operation of the vacuum circuit breaker, a concentration of electrical field at the triple junction of metal end cap ceramic tube and vacuum chamber.

2. Ceramic tube according to claim 1, in which the cylindrical end face on an inner side of the ceramic tube forms an angle of substantially at most 90° with an inner surface of the ceramic tube.

3. Ceramic tube according to claim 1, in which the cylindrical end face on an outer side of the ceramic tube forms an angle of at least 90° with an outer surface of the ceramic tube.

4. Vacuum circuit breaker provided with a ceramic tube according to claim 1.

5. Ceramic tube according to claim 2, in which the cylindrical end face on an outer side of the ceramic tube forms an angle of at least 90° with an outer surface of the ceramic tube.

6. Vacuum circuit breaker provided with a ceramic tube according to claim 2.

7. Vacuum circuit breaker provided with a ceramic tube according to claim 6, in which the cylindrical end face on an outer side of the ceramic tube forms an angle of at least 90° with an outer surface of the ceramic tube.
